(19) United States
(12) Patent Application Publication
(10) Pub. No.: US 2015/0175871 A1
(43) Pub. Date: Jun. 25, 2015

(54) BREAKER FLUID

(71) Applicant: M-I, L.L.C., Houston, TX (US)

(72) Inventors: Sashikumar Mettath, Houston, TX (US); Mark Luyster, Houston, TX (US)

(73) Assignee: M-I, L.L.C., Houston, TX (US)

(21) Appl. No.: 14/414,090

(22) PCT Filed: Jul. 9, 2013
(86) PCT No.: PCT/US2013/049649

§ 371 Date: Jan. 9, 2015

Related U.S. Application Data
(60) Provisional application No. 61/669,539, filed on Jul. 9, 2012.

(51) Int. Cl. C09K 8/52; E21B 43/04; E21B 37/06

(52) U.S. Cl. CPC C09K 8/52; E21B 37/06; E21B 43/04

(57) ABSTRACT

A breaker fluid composition and methods for using said breaker fluid composition are provided, where the breaker fluid includes a non-aqueous base fluid, a precipitated silica, an acid source, and, in some embodiments, a chelant.

### BACKGROUND

During the drilling of a wellbore, various fluids are typically used in the well for a variety of functions. The fluids may be circulated through a drill pipe and drill bit into the wellbore, and then may subsequently flow upward through the wellbore to the surface. During this circulation, the drilling fluid may act to remove drill cuttings from the bottom of the hole to the surface, cool and lubricate the drill string and bit, and/or to maximize penetration rate suspend cuttings and weighting material and when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore.

One way of protecting the formation is by forming a filtercake on the surface of the subterranean formation. Filter cakes are formed when particles suspended in a wellbore fluid block and plug the pores in the subterranean formation such that the filtercake prevents or reduce both the loss of fluids and solids into the formation and the influx of fluids present in the formation. A number of ways of forming filter cakes are known in the art, including the use of bridging particles, cuttings created by the drilling process, polymeric additives, and precipitates. Fluid loss pills may also be used where a viscous pill comprising a polymer may be used to reduce the rate of loss of a wellbore fluid to the formation through its viscosity.

Upon completion of drilling, the filtercake and/or fluid loss pill may stabilize the wellbore during subsequent completion operations such as placement of a gravel pack in the wellbore. Additionally, during completion operations, when fluid loss is suspected, a fluid loss pill of polymers may be spotted into the wellbore to reduce or prevent such fluid loss by injection of other completion fluids behind the fluid loss pill to a position within the wellbore which is immediately above a portion of the formation where fluid loss is suspected. Injection of fluids into the wellbore is then stopped, and fluid loss will then move the pill toward the fluid loss location.

After any completion operations have been accomplished, removal of filtercake (formed during drilling and/or completion) remaining on the sidewalls of the wellbore may be initiated. Although filtercake formation and use of fluid loss pills occur during drilling and completion operations, these barriers can be an impediment to the production of hydrocarbon or other fluids from the well if, for example, the rock formation is still plugged by the barrier. Because filtercake is compact, it often adheres strongly to the formation and may not be readily or completely flushed out of the formation by fluid action alone.

The removal of filtercake has been conventionally achieved with water based treatments that include: an aqueous solution with an oxidizer (such as persulfate), a hydrochloric acid solution, organic (acetic, formic) acid, combinations of acids and oxidizers, and aqueous solutions containing enzymes. For example, the use of enzymes to remove filtercake is disclosed in U.S. Pat. No. 4,169,818. Chelating agents (e.g., EDTA) have also been used to promote the dissolution of calcium carbonate. According to traditional teachings, the oxidizer and enzyme attack the polymer fraction of the filtercake and the acids typically attack the carbonate fraction (and other minerals). Generally, oxidizers and enzymes are ineffective in dissolving and/or degrading the carbonate portion of the filtercake.

Efficient well clean-up, stimulation, and skin-free completions are desired especially in open-hole and high-angle type completions. The productivity of a well is somewhat dependent on effectively and efficiently removing the filtercake while minimizing the potential of water blocking, plugging of a sand control screen (when employed), or otherwise damaging the natural flow channels of the formation, as well as those of the completion assembly. Thus there exists a continuing need for completion and displacement fluids that effectively clean the well bore and do not inhibit the ability of the formation to produce hydrocarbons once the well is brought on-line or initial production.

Accordingly, there exists a continuing need for breaker fluids that effectively clean the well bore and do not inhibit the ability of the formation to produce hydrocarbons once the well is brought on-line or initial production.

### SUMMARY

In embodiments, a breaker fluid that includes a non-aqueous base fluid, a precipitated silica, and an acid source is provided.

In other embodiments, a method of cleaning a wellbore is provided, the method including: emplacing a non-aqueous breaker fluid into the wellbore proximate a filter cake, the breaker fluid including: an oleaginous base fluid, a precipitated silica, and an acid source; and shutting in the well for a period of time.

In some embodiments, a method for completing a wellbore is provided, including: drilling the wellbore with a drilling fluid and forming a filtercake on the walls thereof; gravel packing at least one interval of the wellbore; emplacing a breaker fluid into the wellbore, the breaker fluid including: an oleaginous base fluid, a precipitated silica, and an acid source.

Other aspects and advantages of the present disclosure will be apparent from the following description and the appended claims.

### DETAILED DESCRIPTION

Embodiments disclosed herein generally relate to non-aqueous breaker fluids and methods of use thereof

Often, before completions operations such as filtercake removal are initiated, drilling muds are displaced by circulating spacer fluids throughout the well. During displacement, typically, when switching from drilling with an oil-based mud or water-based mud, the fluid in the wellbore is displaced with a different fluid such as a spacer. For example, an oil-based mud in the open-hole section may be displaced using another oil-based spacer fluid that comprises no solids, less solids, or solids that are sized to reduce plugging potential of the selected sand control screen, and if transitioning to an aqueous wellbore fluid such as a breaker fluid, a spacer may be used in this process.

As mentioned above, breaker fluids are designed to destroy the integrity of a residual filtercake created during the drilling process by removing some or all drilling fluid components that formed the filter cake. In many instances, breaker fluids may be formulated using aqueous base fluids, which are subsequently used to degrade both water- and oil-based filter cakes. However, when using an oil-based drilling fluid, it may be desirable to use a non-aqueous system or an invert emulsion system. In addition to increasing compatibility and delivery of filtercake disrupting reagents, the use of non-aqueous or invert breaker fluids may reduce or eliminate the need for spacers prior to degradation of the filtercake, to attain required differential pressure and hydrostatic pressure once pumping ceases.

However, non-aqueous (or invert) breaker fluids have not conventionally been practical due to density limitations and environmental limitations with non-solid weighting agents viewed to be compatible with the base fluid (e.g., chlorofluorocarbons and iron-based agents). It has been ascertained that precipitated silica may be used as both a weighting agent and a rheological additive. In addition, the incorporation of precipitated silica as a weighting agent may reduce or eliminate the need to incorporate brines or other aqueous fluids into the breaker fluid.

Precipitated Silicas

Silicas have been used in wellbore fluids as weighting agents, consolidating treatments, proppants, desiccants, and additives for rubber compositions. The methods used to prepare silicas may alter many of the morphological characteristics of the final silica product. For example, fumed or pyrogenic silicas are non-porous and water-soluble, have a low bulk density, high surface area, and are often used as rheological additives for aqueous and invert emulsion fluid systems. This is in stark contrast to precipitated silicas, which may have a porous structure, and are useful in embodiments herein as a viscosifying or viscosifying/weighting agent.

Precipitated silicas having a porous structure may be prepared from the reaction of an alkaline silicate solution with a mineral acid. Alkaline silicates may be selected, for example, from one or more of sodium silicate, potassium silicate, lithium silicate and quaternary ammonium silicates. Precipitated silicas may be produced by the destabilization and precipitation of silica from soluble silicates by the addition of a mineral acid and/or acidic gases. The reactants thus include an alkali metal silicate and a mineral acid, such as sulfuric acid, or an acidulating agent, such as carbon dioxide. Precipitation may be carried out under alkaline conditions, for example, by the addition of a mineral acid and an alkaline silicate solution to water with constant agitation. The choice of agitation, duration of precipitation, the addition rate of reactants, temperature, concentration, and pH may vary the properties of the resulting silica particles.

In some embodiments, a precipitated silica or surface-modified precipitated silica may be present in breaker fluids according to embodiments herein in the range from about 5 to greater than 40 ppb or 50 ppb, such as about 10 ppb to about 35 ppb.

Precipitated silicas useful in embodiments herein may include finely-divided particulate solid materials, such as powders, silts, or sands, as well as reinforced flocs or agglomerates of smaller particles of siliceous material. In some embodiments, the precipitated silica (or agglomerates thereof) may have an average particle size (D₅₀) of less than 100 microns; less than 50 microns in other embodiments; and in the range from about 1 micron to about 40 microns, such as about 25 to about 35 microns, in yet other embodiments. In some embodiments, precipitated silicas having a larger initial average particle size may be used, where shear or other conditions may result in comminution of the particles, such as breaking up of agglomerates, resulting in a silica particle having a useful average particle size.

Precipitated silicas may contain varying amounts of residual alkali metal salts that result from the association of the corresponding silicate counterion with available anions contributed by the acid source. Residual salts may have the basic formula MX, where M is a group 1 alkali metal selected from Li, Na, K, Cs, a group 2 metal selected from Mg, Ca, and Ba, or organic cations such as ammonium, tetraalkyl ammonium, imidazolium, alkyl imidazolium, and the like; and X is an anion selected from halides such as F, Cl, Br, I, and/or sulfates, sulfonates, phosphonates, perchlorates, borates, and nitrates. In an embodiment, the residual salts may be selected from one or more of Na₂SO₄ and NaCl, and the precipitated silica may have a residual salt content (equivalent Na₂SO₄) of less than about 2 wt. %. While the pH of the resulting precipitated silicas may vary, embodiments of the silicas useful in embodiments disclosed herein may have a pH in the range from about 6.5 to about 9, such as in the range from about 6.8 to about 8.

In other embodiments, surface-modified precipitated silicas may be used. The surface-modified precipitated silica may include a lipophilic coating, for example. The surface modification may be added to the silica after precipitation. Alternatively, the silica may be precipitated in the presence of one or more of the surface modification agents described below.

It has been found that surface-modified precipitated silicas according to embodiments herein may provide for both weighting and viscosifying of the oleaginous base fluid. Precipitated silicas according to embodiments herein are useful for providing wellbore fluids having enhanced thermal stability in temperature extremes, while exhibiting a substantially constant rheological profile over time.

In some embodiments, the surface of the silica particles may be chemically modified by a number of synthetic techniques. Surface functionality of the particles may be tailored to improve solubility, dispersibility, or introduce reactive functional groups. This may be achieved by reacting the precipitated silica particles with organosilanes or siloxanes, in which reactive silane groups present on the molecule may become covalently bound to the silica lattice that makes up the particles. Non-limiting examples of compounds that may be used to functionalize the surface of the precipitated silica particles include aminoalkylsilanes such as aminopropyltriethoxysilane, aminomethyltriethoxysilane, trimethoxy [3-(phenylamino)propyl]silane, and trimethyl[3-(triethoxysilyl)propyl]ammonium chloride; alkoxyorganomercapto silanes such as bis(3-(triethoxysilylpropyl) tetrasulfide, bis (3-(triethoxysilylpropyl) disulfide, vinyltrimethoxy silane, vinyltriethoxy silane, 3-mercaptopropyltrimethoxy silane; 3-mercaptopropyltriethoxy silane; 3-aminopropyltriethoxysilane and 3-aminopropyltrimethoxysilane; and alkoxysilanes.

In other embodiments, organo-silicon materials that contain reactive end groups may be covalently linked to the surface of the silica particles. Reactive polysiloxanes may include, for example, diethyl dichlorosilane, phenyl ethyl diethoxy silane, methyl phenyl dichlorosilane, 3,3,3-trifluoropropylmethyl dichlorosilane, trimethylbutoxy silane, sym-diphenyltetramethyl disiloxane, octamethyl trisiloxane, octamethyl cyclotetrasiloxane, hexamethyl disiloxane, pentamethyl dichlorosilane, trimethyl chlorosilane, trimethyl methoxysilane, trimethyl ethoxysilane, methyl trichlorosilane, methyl triethoxysilane, methyl trimethoxysilane, hexamethyl cyclotrisiloxane, hexamethyldisiloxane, hexaethyldisiloxane, dimethyl dichlorosilane, dimethyl dimethoxy silane, dimethyl diethoxysilane, polydimethylsiloxanes comprising 3 to 200 dimethylsiloxy units, trimethyl siloxy or hydroxydimethylsiloxy end blocked poly(dimethylsiloxane) polymers (silicone oils) having an apparent viscosity within the range of from 1 to 1000 mPascals at 25° C., vinyl silane, gamm-methacryloxypropyl trimethoxy silane, polysiloxanes, e.g., polysiloxane spheres, and mixtures of such organo-silicone materials.

The surface-modified precipitated silicas may have a BET-5 nitrogen surface area of less than about 200 m²/g. In some embodiments, the surface area of the surface-modified precipitated silica may be less than about 150 m²/g. In other embodiments, the surface area may be in the range from about 20 m²/g to about 70 m²/g.

In one or more embodiments, the precipitated silica has a BET-5 nitrogen surface area of 20 m²/g to 70 m²/g, as calculated from the surface adsorption of N₂ using the BET-1 point method, a pH in the range of pH 7.5 to pH 9, and an average particle diameter in the range of 20 nm to 100 nm.

In some embodiments, surface-modified precipitated silicas useful in embodiments herein may include those as disclosed in U.S. Patent Application Publication Nos. 2010/0292386, 2008/0067468, 2005/0131107, 2005/0176852, 2006/0225615, 2006/0228632, and 2006/0281009, for example.

Acid Sources

Breaking of water-based and oil-based filter cakes may occur by exposure of the filtercake to a compound having an oleophilic portion that can penetrate into the filtercake, disrupting the adhesion of the filtercake to the walls of the wellbore, while simultaneously fragmenting and removing the filtercake. Such compounds may be referred to herein as fragmentation agents. Fragmentation agents may include, for example, fatty acids, derivatives thereof, hydrocarbon solvents, etc. Such agents are discussed in greater detail in U.S. Patent Application No. 61/088,878, which is assigned to the present assignee and herein incorporated by reference in its entirety. In a particular embodiment, a fragmentation agent may include an alkyl aryl sulfonate, an example of which includes dodecylbenzyl sulfonic acid, to provide for reaction with calcium carbonate in the filter cake. Another embodiment may use fatty acids such as butyric acid (C4), caproic acid (C6), caprylic acid (C8), capric acid (C10), lauric acid (C12), mysristic acid (C14), palmitic acid (C16), stearic acid (C18), etc, in addition to unsaturated fatty acids such as myristoleic acid (C14), palmitoleic acid (C16), oleic acid (C18), linoleic acid (C18), alpha-linoleic acid (C18), erucic acid (C22), etc, or mixtures thereof In addition to these fatty acids, the compounds may also have a small degree of substitution/branching or may be sulfonic or phosphonic derivatives thereof Alternatively, fragmentation/penetrability of a filtercake may be achieved (and/or increased) with the use of hydrocarbon solvents such as d-limonene, hexane, decane, xylene, and other C₂-C₁₅ hydrocarbon solvents, etc.

The breaker fluids of the present disclosure may also be formulated to contain an acid source to decrease the pH of the breaker fluid and aid in the degradation of filtercakes within the wellbore. Examples of acid sources that may be used as breaker fluid additives include strong mineral acids, such as hydrochloric acid or sulfuric acid, and organic acids, such as citric acid, salicylic acid, lactic acid, malic acid, acetic acid, and formic acid. Suitable organic acids that may be used as the acid sources may include citric acid, salicylic acid, glycolic acid, malic acid, maleic acid, fumaric acid, and homo- or copolymers of lactic acid and glycolic acid as well as compounds containing hydroxy, phenoxy, carboxylic, hydroxycarboxylic or phenoxycarboxylic moieties.

Alternatively, a delayed acid source may be used which reduces the pH of the wellbore fluid over a period of time. In particular, compounds that hydrolyze to form acids in situ may be utilized. Such delayed source of acidity may be provided, for example, by hydrolysis of an ester or amide. It is well known in the art that temperature, as well as the presence of hydroxide ion source, has a substantial impact on the rate of hydrolysis of esters. For a given acid, such as formic acid, for example, one of skill in the art can conduct simple studies to determine the time to hydrolysis at a given temperature. It is also known that as the length of the alcohol portion of the ester increases, the rate of hydrolysis decreases. Thus, by systematically varying the length and branching of the alcohol portion of the ester, the rate of release of acid may be controlled, and thus the setting of the wellbore fluid may be predetermined

Illustrative examples of such delayed acid sources include hydrolyzable anhydrides of carboxylic acids, hydrolyzable esters of carboxylic acids, hydrolyzable esters of phosphonic acid, and hydrolyzable esters of sulfonic acid. Breaker fluids in accordance with this disclosure may include delayed acid sources such as, for example, R¹H₂PO₃, R¹R²HPO₃, R¹R²R³PO₃, R¹HSO₃, R¹R²SO₃, R¹H₂PO₄, R¹R²HPO₄, R¹R²R³PO₄, R¹HSO₄, or R¹R²SO₄, where R¹, R², and R³ are C₂ to C₃₀ alkyl-, aryl-, arylalkyl-, or alkylaryl-groups.

Further examples of delayed acid sources include esters of alcohols comprising 2 to 12 carbons, esters derived from mono or polyunsaturated fatty acids having 16 to 24 carbons, ester blends comprising isomerized and/or internal olefins, hydroxycarboxylic acids formed by the hydrolysis of lactones, such as δ-lactone and γ-lactone), or combinations of any of the above esters. Other similar hydrolyzable compounds such as amides that should be well known to those skilled in the art and are within the scope of this disclosure.

Additionally, depending on the expected downhole temperature and corresponding expected hydrolysis rate of the selected ester, it may be desirable to incorporate an enzyme, such as lipases, esterases, and proteases, into the wellbore fluid containing the ester so as to increase the rate of hydrolysis. Further, while temperatures greater than 120° F. typically do not require the incorporation of an enzyme due to sufficiently high hydrolysis rates, it is contemplated that other esters (having lower hydrolysis rates that would not generally be used) may be used in conjunction with an enzyme to increase the inherently low hydrolysis rate.

In some embodiments, an acid source may be present in an amount ranging from 5 to 30 vol % of the wellbore fluid. The breaker fluid may have a pH below 4 or below 3 in another embodiment. Delayed acid sources may be incorporated into the breaker fluid composition, wherein the delayed acid source is 5-30% of the total breaker fluid volume in an embodiment. In another embodiment, the delayed acid source may make up 5-50% of the total volume of the breaker fluid.

In some embodiments, the hydrolysable ester is selected so that the time to achieve hydrolysis is predetermined on the known downhole conditions, such as temperature. It is well known in the art that temperature, as well as the presence of a hydroxide ion source, has a substantial impact on the rate of hydrolysis of esters. For a given acid, for example formic acid, one of skill in the art can conduct simple studies to determine the time to hydrolysis at a given temperature. It is also well known that as the length of the alcohol portion of the ester increases, the rate of hydrolysis decreases. Thus, by systematically varying the length and branching of the alcohol portion of the ester, the rate of release of the formic acid can be controlled and thus the breaking of the emulsion of an invert emulsion filter cake can be predetermined In one embodiment, the hydrolysable ester of a carboxylic acid is a formic acid ester of a C2 to C30 alcohol. In another embodiment the hydrolysable ester is C1 to C6 carboxylic acid and a C2 to C30 poly alcohol including alkyl orthoesters may be used. In yet another embodiment, the hydrolysable ester of carboxylic acid is ethanediol monoformate. In still another embodiment, the hydrolysable ester may be combined with a solvent. Examples of such solvents include organic solvents such as ethylene glycol. When ethanediol monoformate is combined with ethylene glycol solvent, the resulting solution may also include the hydrolysable esters of carboxylic acid ethylene glycol monoformate and ethylene glycol diformate.

Chelants

Chelants, also referred to as chelating agents or chelators, useful as breaking agents in the embodiments disclosed herein may sequester polyvalent cations through bonds to two or more atoms of the chelant. Chelants may act to remove structural components from the filtercake, weakening the overall structure of the filtercake and aiding in its removal. For example, cations sequestered by the chelants may be sourced from solid filtercake components including various weighting or bridging agents such as calcium carbonate, barium sulfate, etc. Useful chelants may include organic ligands such as ethylenediamine, diaminopropane, diaminobutane, diethylenetriamine, triethylenetetraamine, tetraethylenepentamine, pentaethylenehexamine, tris(aminoethyl)amine, triaminopropane, diaminoaminoethylpropane, diaminomethylpropane, diaminodimethylbutane, bipyridine, dipyridylamine, phenanthroline, aminoethylpyridine, terpyridine, biguanide and pyridine aldazine.

In some embodiments, the chelant that may be used may be a polydentate chelator such that multiple bonds are formed with the complexed metal ion. Polydentate chelants suitable may include, for example, ethylenediaminetetraacetic acid (EDTA), diethylenetriaminepentaacetic acid (DTPA), nitrilotriacetic acid (NTA), ethylene glycol-bis(2-aminoethyl)-N,N,N′,N′-tetraacetic acid (EGTA), 1,2-bis(o-aminophenoxy)ethane-N,N,N′,N′-tetraac etic ac id (BAPTA), cyclohexanediaminetetraacetic acid (CDTA), triethylenetetraaminehexaacetic acid (TTHA), N-(2-Hydroxyethyl)ethylenediamine-N,N′,N′-triacetic acid (HEDTA), glutamic-N,N-diacetic acid (GLDA), ethylene-diamine tetra-methylene sulfonic acid (EDTMS), diethylene-triamine penta-methylene sulfonic acid (DETPMS), amino tri-methylene sulfonic acid (ATMS), ethylene-diamine tetra-methylene phosphonic acid (EDTMP), diethylene-triamine penta-methylene phosphonic acid (DETPMP), amino tri-methylene phosphonic acid (ATMP), salts thereof, and mixtures thereof However, this list is not intended to have any limitation on the chelating agents suitable for use in the embodiments disclosed herein. One of ordinary skill in the art would recognize that selection of the chelant may depend on the metals present downhole in the filtercake. In particular, the selection of the chelant may be related to the specificity of the chelant to the particular cations, the log K value, the optimum pH for sequestering and the commercial availability of the chelating agent, as well as downhole conditions, etc.

In a particular embodiment, the chelant used to dissolve metal ions may be EDTA or salts thereof Salts of EDTA may include, for example, alkali metal salts such as a tetrapotassium salt or tetrasodium salt. However, as the pH of the dissolving solution is altered in the processes disclosed herein, a di- or tri-potassium or salt or the acid may be present in the solution.

However, to dissolve or sequester some metals (for example, barium), stronger chelating agents may need to be used. For example, of several example chelating agents, the chelating power is, from strongest to weakest, DTPA, EDTA, GLDA, and HEDTA. Thus, incorporation of a chelant into a breaker fluid may serve to dissolve and chelate metals present in the filtercake to aid in dissolution or degradation of the filtercake.

In other embodiments, chelants in the embodiments disclosed herein may be delayed or inactivated chelants. Delayed chelants are chelants in which the moieties that actively bind substrates, i.e. amines, carboxylates, hydroxyls, etc., have been passivated by reversible reactions with a protecting group. Passivation or inactivation of the chelants may be achieved through modification of the chelant with protecting groups such as acetyl, benzoyl, benzyl, carbamates, nitriles, and esters, for example. Other protecting strategies are well known in the art and may be employed without deviating from the scope of this disclosure.

Suitable delayed chelants may include, for example, amido-chelants and esterified-chelants such as polyethyl esters or amides, internal cyclic esters or amides, nitrile-chelants, anhydride-chelants and combinations thereof

Delayed chelants may be hydrolyzed to release a strong or activated chelant by elevated temperature, hydrolysis by a suitable enzyme, or hydrolysis in elevated or reduced pH. Inactivation of a chelant may be reversed upon exposure to a chemical or physical signal such as by altering the surrounding environment. According to embodiments of the present disclosure, the inactive chelant may be activated by introduction of a triggering agent, for example, by injecting a hydrolyzing agent such as an enzyme into the wellbore fluid environment, by thermally hydrolyzing the inactive chelating agent, and/or decreasing or increasing the pH by the addition of acids or bases.

One of ordinary skill in the art should appreciate that other agents or additives may be introduced to the wellbore fluid environment to trigger the release of an activated chelating agent, and/or rely on the temperature of the wellbore to hydrolyze the amides, esters, nitriles, and anhydrides to an activated chelant.

Solid Weighting Agents

If necessary, the density of the fluid may be increased by incorporation of a solid weighting agent. Solid weighting agents, with varying particle size, used in some embodiments disclosed herein may include a variety of inorganic compounds well known to one of skill in the art. In some embodiments, the weighting agent may be selected from one or more of the materials including, for example, barium sulphate (barite), calcium carbonate (calcite or aragonite), dolomite, ilmenite, hematite or other iron ores, olivine, siderite, manganese oxide, and strontium sulphate. In a particular embodiment, calcium carbonate or another acid soluble solid weighting agent may be used. In another embodiment, a non-soluble solid may be desired, such as silica, as described above.

One having ordinary skill in the art would recognize that selection of a particular material may depend largely on the density of the material because generally the lowest wellbore fluid viscosity at any particular density is obtained by using the highest density particles. In some embodiments, the weighting agent may be formed of particles that are composed of a material of specific gravity of at least 2.3; at least 2.4 in other embodiments; at least 2.5 in other embodiments; at least 2.6 in other embodiments; and at least 2.68 in yet other embodiments. Higher density weighting agents may also be used with a specific gravity of about 4.2, 4.4 or even as high as 5.2. For example, a weighting agent formed of particles having a specific gravity of at least 2.68 may allow wellbore fluids to be formulated to meet most density requirements yet have a particulate volume fraction low enough for the fluid to be pumpable. However, other considerations may influence the choice of product such as cost, local availability, the power required for grinding, and whether the residual solids or filtercake may be readily removed from the well. In particular embodiments, the wellbore fluid may be formulated with calcium carbonate or another acid-soluble material.

The solid weighting agents may be of any particle size (and particle size distribution), but some embodiments may include weighting agents having a smaller particle size range than API grade weighing agents, which may generally be referred to as micronized weighting agents. Such weighting agents may generally be in the micron (or smaller) range, including submicron particles in the nanosized range.

In some embodiments, the average particle size (d50) of the weighting agents may range from a lower limit of greater than 5 nm, 10 nm, 30 nm, 50 nm, 100 nm, 200 nm, 500 nm, 700 nm, 0.5 micron, 1 micron, 1.2 microns, 1.5 microns, 3 microns, 5 microns, or 7.5 microns to an upper limit of less than 500 nm, 700 microns, 1 micron, 3 microns, 5 microns, 10 microns, 15 microns, 20 microns, where the particles may range from any lower limit to any upper limit. In other embodiments, the d90 (the size at which 90% of the particles are smaller) of the weighting agents may range from a lower limit of greater than 20 nm, 50 nm, 100 nm, 200 nm, 500 nm, 700 nm, 1 micron, 1.2 microns, 1.5 microns, 2 microns, 3 microns, 5 microns, 10 microns, or 15 microns to an upper limit of less than 30 microns, 25 microns, 20 microns, 15 microns, 10 microns, 8 microns, 5 microns, 2.5 microns, 1.5 microns, 1 micron, 700 nm, 500 nm, where the particles may range from any lower limit to any upper limit. The above described particle ranges may be achieved by grinding down the materials to the desired particle size or by precipitation of the material from a bottoms up assembly approach. Precipitation of such materials is described in U.S. Patent Application Publication No. 2010/009874, which is assigned to the present assignee and herein incorporated by reference. One of ordinary skill in the art would recognize that, depending on the sizing technique, the weighting agent may have a particle size distribution other than a monomodal distribution. That is, the weighting agent may have a particle size distribution that, in various embodiments, may be monomodal, which may or may not be Gaussian, bimodal, or polymodal.

In one embodiment, a weighting agent is sized such that: particles having a diameter less than 1 microns are 0 to 15 percent by volume; particles having a diameter between 1 microns and 4 microns are 15 to 40 percent by volume; particles having a diameter between 4 microns and 8 microns are 15 to 30 by volume; particles having a diameter between 8 microns and 12 microns are 5 to 15 percent by volume; particles having a diameter between 12 microns and 16 microns are 3 to 7 percent by volume; particles having a diameter between 16 microns and 20 microns are 0 to 10 percent by volume; particles having a diameter greater than 20 microns are 0 to 5 percent by volume. In another embodiment, the weighting agent is sized so that the cumulative volume distribution is: less than 10 percent or the particles are less than 1 micron; less than 25 percent are in the range of 1 micron to 3 microns; less than 50 percent are in the range of 2 microns to 6 microns; less than 75 percent are in the range of 6 microns to 10 microns; and less than 90 percent are in the range of 10 microns to 24 microns.

The use of weighting agents having such size distributions has been disclosed in U.S. Patent Application Publication Nos. 2005/0277553 and 2010/0009874, which are assigned to the assignee of the current application, and herein incorporated by reference. Particles having these size distributions may be obtained any means known in the art.

In some embodiments, the weighting agents include dispersed solid colloidal particles with a weight average particle diameter (d50) of less than 10 microns that are coated with an organophilic, polymeric deflocculating agent or dispersing agent. In other embodiments, the weighting agents include dispersed solid colloidal particles with a weight average particle diameter (d50) of less than 8 microns that are coated with a polymeric deflocculating agent or dispersing agent; less than 6 microns in other embodiments; less than 4 microns in other embodiments; and less than 2 microns in yet other embodiments. The fine particle size will generate suspensions or slurries that will show a reduced tendency to sediment or sag, and the polymeric dispersing agent on the surface of the particle may control the inter-particle interactions and thus will produce lower rheological profiles. It is the combination of fine particle size and control of colloidal interactions that reconciles the two objectives of lower viscosity and minimal sag.

In some embodiments, the weighting agents may be uncoated. In other embodiments, the weighting agents may be coated with an organophilic coating such as a dispersant, including carboxylic acids of molecular weight of at least 150 Daltons, such as oleic acid, stearic acid, and polybasic fatty acids, alkylbenzene sulphonic acids, alkane sulphonic acids, linear alpha-olefin sulphonic acid, and alkaline earth metal salts thereof. Further examples of suitable dispersants may include a polymeric compound, such as a polyacrylate ester composed of at least one monomer selected from stearyl methacrylate, butylacrylate and acrylic acid monomers. The illustrative polymeric dispersant may have an average molecular weight from about 10,000 Daltons to about 200,000 Daltons and in another embodiment from about 17,000 Daltons to about 30,000 Daltons. One skilled in the art would recognize that other acrylate or other unsaturated carboxylic acid monomers (or esters thereof) may be used to achieve substantially the same results as disclosed herein.

In embodiments, the coated weighting agents may be formed by either a dry coating process or a wet coating process. Weighting agents suitable for use in other embodiments disclosed herein may include those disclosed in U.S. Patent Application Publication Nos. 2004/0127366, 2005/0101493, 2006/0188651, 2008/0064613, and U.S. Pat. Nos. 6,586,372 and 7,176,165.

The particulate materials as described herein (i.e., the coated and/or uncoated weighting agents) may be added to a wellbore fluid as a weighting agent in a dry form or concentrated as slurry in either an aqueous medium or as an organic liquid. As is known, an organic liquid may have the environmental characteristics required for additives to oil-containing wellbore fluids. With this in mind, the oleaginous fluid may have a kinematic viscosity of less than 10 centistokes (10 mm2/s) at 40° C. and, for safety reasons, a flash point of greater than 60° C. Suitable oleaginous liquids are, for example, diesel oil, mineral or white oils, n-alkanes or synthetic oils such as alpha-olefin oils, ester oils, mixtures of these fluids, as well as other similar fluids known to one of skill in the art of drilling or other wellbore fluid formulation. In one embodiment, the desired particle size distribution is achieved via wet milling of the coarser materials in the desired carrier fluid.

Such solid weighting agents may be particularly useful in wellbore fluids formulated with an entirely oleaginous fluid phase. In a particular embodiment, an organophilic coated weighting agent having a particle size within any of the described ranges may be used in a fluid free of or substantially free of an aqueous phase contained therein. Solid weighting agents may also be used in the direct emulsion emulsions of the present disclosure to provide additional density beyond that provided by the aqueous phase as needed.

Base Fluids

The breaker fluid may be formulated using an aqueous, non-aqueous or oleaginous base fluid. The oleaginous fluid may be a liquid such as a natural or synthetic oil, and the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof

In one or more embodiments, the breaker fluids may include an invert emulsion, which includes an oleaginous continuous phase and a non-oleaginous discontinuous phase. The concentration of the oleaginous fluid should be sufficient so that an invert emulsion forms and may be less than about 99% by volume of the invert emulsion. In one embodiment the amount of oleaginous fluid is from about 30% to about 95% by volume and, in another embodiment, about 40% to about 90% by volume of the invert emulsion fluid. The oleaginous fluid in one embodiment may include at least 5% by volume of a material selected from the group including esters, ethers, acetals, dialkylcarbonates, hydrocarbons, and combinations thereof In a particular embodiment, at least a portion of the oleaginous fluid includes at least one hydrolysable ester, such as those described above to allow for lowering of the pH of the wellbore fluid, triggering the degradation and removal of an oil-based filtercake. Thus, in various embodiments, the oleaginous fluid may be formed from 0 to 100 percent by volume of an ester. However, when including an ester, an amount ranging from 3-30 volume percent may be desirable.

The non-oleaginous fluid, when used in the formulation of the invert emulsion fluid disclosed herein, is a liquid, such as an aqueous liquid. In one or more embodiments, the non-oleaginous liquid may be selected from the group including sea water, brines containing organic and/or inorganic dissolved salts such as alkali metal chlorides, hydroxides, or carboxylates, or aqueous liquids containing water-miscible organic compounds, and combinations thereof, for example. The amount of the non-oleaginous fluid is typically less than the theoretical limit needed for forming an invert emulsion. Thus, in one embodiment, the amount of non-oleaginous fluid is less that about 70% by volume and, in another embodiment, from about 1% to about 70% by volume. In another embodiment, the non-oleaginous fluid is from about 5% to about 60% by volume of the invert emulsion fluid. In a particular embodiment, various weighting agents, emulsifiers, and rheological additives may be included in a wellbore fluid formulation.

In various embodiments of the wellbore fluid disclosed herein, the brine may include fresh water, seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium, salts of chlorides, bromides, carbonates, iodides, chlorates, bromates, formates, nitrates, oxides, phosphates, sulfates, silicates, and fluorides. Salts that may be incorporated in a given brine include any one or more of those present in natural seawater or any other organic or inorganic dissolved salts.

Additionally, brines that may be used in the wellbore fluids disclosed herein may be natural or synthetic, with synthetic brines tending to be much simpler in constitution. In one embodiment, the density of the wellbore fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium. Specific examples of such salts, include but are not limited to, NaCl, CaCl₂, NaBr, CaBr₂, ZnBr₂, NaHCO₂, KHCO₂, KCl, NH₄Cl, CsHCO₂, MgCl₂, MgBr₂, KH₃C₂O₂, KBr, NaH₃C₂O₂ and combinations thereof

In one embodiment, the breaker fluid includes a hydrolysable ester of carboxylic acid and a chelant. The breaker fluid may include an amount of water less than required to completely hydrolyze the ester. In another embodiment, the fluid includes an amount of water wherein the weight ratio of water to hydrolysable ester of carboxylic acid is less than 1.3. The 1.3 ratio of water to hydrolysable ester of carboxylic acid is approximately the amount of water that would hydrolyze the ester in the breaker fluid.

In some embodiments, the wellbore fluid may be an invert emulsion. In other embodiments, the wellbore fluid may be a direct emulsion.

In some embodiments, the breaker fluid may be considered an “all-oil” based breaker fluid. As used herein, “all-oil” refers to the fluid being essentially free of free water. In such instances, the breaker fluid would rely on water present in the wellbore. The viscosity of the breaker fluid resulting from the precipitated silica may thus restrict transport properties of the water in the wellbore (such as from a filter cake formed from an aqueous wellbore fluid) through the fluid, lowering mobility and increasing the delay in activating the breaker as it requires scavenging water from the formation and aqueous-based filter cake. This may result in the filter cake remaining in place for an additional time, which may provide substantial benefits to the drilling or wellbore operation. The additional delay also helps with operability, i.e., the time required to transport the breaker downhole.

Breaker Fluid Additives

The breaker fluids of the present disclosure may also include oxidizers, enzymes, mutual solvents, fragmentation agents, or other solvents that are conventionally used to break filtercakes, fluid loss pills, or gravel packs.

In some embodiments, using a breaker fluid may include a natural polymer degrading enzyme, for example, a carbohydrase. Examples of such enzymes include amylases, pullulanases, and cellulases. In other embodiments, the enzyme may be selected from endo-amylase, exo-amylase, isoamylase, glucosidase, amylo-glucosidase, malto-hydrolase, maltosidase, isomalto-hydrolase or malto-hexaosidase. One skilled in the art would appreciate that selection of an enzyme may depend on various factors such as the type of polymeric additive used in the wellbore fluid being degraded, the temperature of the wellbore, and the pH of wellbore fluid.

In yet another embodiment, the breaker fluid may include an oxidizing agent, such sodium hypochlorite or peroxides. Suitable oxidizing agents may include hypochlorites, such as lithium and/or sodium hypochlorite and peroxides (including peroxide adducts), other compounds including a peroxy bond such as persulphates, perborates, percarbonates, perphosphates, and persilicates. In a particular embodiment, a peroxide, such as magnesium or calcium peroxide, may be used in the breaker system of the present disclosure. Various breaker fluids and compositions are known in the art and examples are disclosed in Patent Publications 2004/0040706, 2005/0161219, and 2010/0300967.

In one or more embodiments, oxidants may be encapsulated as taught by U.S. Pat. No. 6,861,394, which is assigned to the present assignee and herein incorporated by reference in its entirety. Further, use of an oxidant in a breaker fluid, in addition to affecting polymeric additives, may also cause fragmentation of swollen clays, such as those that cause bit balling. Such oxidants may be present in an amount ranging from about 1 to 10 weight percent of the fluid.

Breaker fluids in accordance with this disclosure may also optionally contain a mutual solvent, which may aid in reducing surface tension and removal of the oil-based filtercake. For example, where increased penetration rate into the filtercake is desired, a mutual solvent may be included to decrease the viscosity of the fluid and increase penetration of the fluid components into the filter cake, causing the fragmentation thereof. Conversely, where additional delay is desired, a lesser amount or zero mutual solvent may be included to increase viscosity and thus reduce penetration rate.

Examples of mutual solvents may include, but are not limited to, a glycol ether or glycerol. In a particular embodiment, the mutual solvent is ethylene glycol monobutyl ether (EGMBE). The use of the term “mutual solvent” includes its ordinary meaning as recognized by those skilled in the art, as having solubility in both aqueous and oleaginous fluids. In some embodiments, the solvent may be substantially completely soluble in each phase while in other embodiments, a lesser degree of solubilization may be acceptable. Further, in a particular embodiment, selection of a mutual solvent may depend on factors such as the type and amount of salt present in the fluid.

Further, the breaker fluid may also contain a surfactant, which may aid in dispersing insoluble solids from the filtercake upon breaking of the filter cake. Specifically, such surfactant may promote water-wetting of solids within the filtercake and disperse active clays. Surfactants or surface active agents have an amphiphilic molecular structure, that is, a structure that is polar (hydrophilic) at one end and nonpolar (lipophilic/hydrophobic) at the other. Generally, hydrophilic groups may be cationic (organic amines—especially with three hydrocarbon chains attached to the nitrogen atom), anionic (fatty acids or sulfates with hydrocarbon chains) or nonionic (organic compounds with oxygen containing groups such as alcohols, esters and ethers) while hydrophobic or lipophilic groups may be large, straight or branched chain hydrocarbons, cyclic hydrocarbons, aromatic hydrocarbons, and/or combinations thereof.

Depending on the type of material in the filtercake to be dispersed, a surfactant having the appropriate HLB may be selected. The term “HLB” (Hydrophilic Lipophilic Balance) refers to the ratio of the hydrophilicity of the polar groups of the surface-active molecules to the hydrophobicity of the lipophilic part of the same molecules. In some embodiments, it may be desirable to have a high (greater than 10) or mid-to-high HLB ranging from 3 to 15, or 5 to 14 in other embodiments. In a particular embodiment, the HLB may range from 7 to 9.

In a particular embodiment, surfactants may include, for example, sorbitan esters and ethers, such as sorbitan monolaurate, stearyl esters such as pyrrolidone carboxylic acid monostearin ester, ethoxylated stearyl stearate, polyoxyethylene distearate, PEG (8) distearate, decaglyceryl tristearate, polyoxyethylene distearate , saccharose distearate, polyethylene glycol (5) glyceryl stearate, polyethylene glycol (5) glyceryl stearate, polyoxyethylene fatty acid esters such as polyoxyethylene fatty acid ester, ethoxylated oleic acid, polyoxyethylene monooleate, polyoxyethylene phenyl ethers such as nonylphenol ethoxylate, polyoxyethylene nonylphenol ether, nonylphenol ethylene oxide condensate, octylphenol ethylene oxide condensate, polyethylene glycol fatty acid esters such as polyethylene glycol 200 monolaurate, polyethylene glycol 400 dioleate, polyglycol-300 oleate, polyoxythylene (5) derivative of distilled lanolin acids, polyethylene glycol (6) oleate, polyglycol oleate, PEG 400 dioleate, polyethylene glycol (5) glyceryl stearate, polyoxyethylene fatty alcohol ethers such as coceth-27, fatty alcohol ethoxylates (C12-C13), cetyl/oleyl alcohol ethylene oxide, tri-ethoxylated tridecyl alcohol, polyoxythylene (5) derivative of distilled lanolin alcohols, laureth-3, natural primary alcohol ethylene oxide condensate, synthetic primary alcohol ethoxylate, polyoxyethylene glycol ethers such as polyoxyalkylene glycol, polyethylene glycol alkyl ethers such as fatty alcohol polyglycol ether, as well as castor oil ethoxylate, nonylphenol polyglycol ether, decaglyceryl trioleate, diglyceryl dioleate, polyoxythylene (6) derivative of sorbitol beeswax, tri-polyoxyethylene ether phosphate, condensate of ethylene oxide, polypropylene glycol ethoxylate, calcium dodecylbenzenesulfonate, branched synthetic alcohol ethoxylate, and polyoxyethylene castor oil ether.

Suitable wetting agents may include fatty acids, organic phosphate esters, modified imidazolines, amidoamines, alkyl aromatic sulfates, and sulfonates. For example, SUREWET®, which is commercially available from M-I LLC, Houston, Texas, is an oil-based wetting agent including oleic acid that may be used to wet fines and drill solids to prevent water-wetting of solids. Moreover, SUREWET® may improve thermal stability, rheological stability, filtration control, emulsion stability of wellbore fluids. Although various wetting agents have been listed above, testing has shown that not all surface-modified precipitated silicas work with most wetting agents, and may be due to compatibility of the surface modification and the wetting agent components. SUREWET®, for example, has been shown to be effective with polysiloxane, aminoalkylsilane, and alkoxyorganomercaptosilane coatings, whereas other wetting agents tested may not exhibit similar compatibility. Accordingly, when used, the wetting agent may be selected to provide a desired interaction with the surface-modified precipitated silica.

Further, one of ordinary skill in the art would appreciate that this list is not exhaustive, and that other surfactants may be used in accordance with embodiments of the present disclosure. Such surface active agents may be used, for example, at about 0.1% to 3% by weight of the fluid, which is sufficient for most applications. However, one of ordinary skill in the art would appreciate that in other embodiments, more or less may be used.

Embodiments of the oil-based breaker fluids disclosed herein may include a base oil, such as an oleaginous fluid, a precipitated silica, an acid source, and a chelant. Additionally, it is within the scope of the disclosure that the addition of chelant to the breaker fluid is optional. In other embodiments, an oil-based breaker fluid may include a base oil, a precipitated silica, and a chelant, where the acid source is optional.

In some embodiments, oil-based breaker fluids disclosed herein may include a base oil, such as an oleaginous fluid, a precipitated silica, a micronized weighting agent, and an organoclay. The use of a micronized weighting agent may be synergistic with the precipitated silica, enhancing the stability of the suspension.

In other embodiments, oil-based breaker fluids disclosed herein may include a base oil, such as an oleaginous fluid, a surface-modified precipitated silica, and an organoclay. The surface-modification of the precipitated silica may provide for stability of the suspension without the need for other additives, although their use is still permitted.

In some embodiments, the oil-based breaker fluids may be considered an “all-oil” system, as described above. In other embodiments, the oil-based breaker fluids may include water.

The breaker fluids disclosed herein may be spotted in the wellbore at the desired location. The breaker fluid is then held in place for a period of time sufficient to break the filter cake.

Breaker fluids of embodiments of this disclosure may be emplaced in the wellbore using conventional techniques known in the art, and may be used in drilling, completion, workover operations, etc. Additionally, one skilled in the art would recognize that such wellbore fluids may be prepared with a large variety of formulations. Specific formulations may depend on the stage in which the fluid is being used, for example, depending on the depth and/or the composition of the formation. The breaker fluids described above may be adapted to provide improved breaker fluids under conditions of high temperature and pressure, such as those encountered in deep wells, where high densities and stability under temperature extremes are required. Non-aqueous breaker fluids may find particular use when the filtercake to be broken and/or the fluid present in the well is an oil-based fluid to improve cleaning efficiency and/or compatibility at fluid interfaces Further, one skilled in the art would also appreciate that other additives known in the art may be added to the breaker fluids of the present disclosure without departing from the scope of the present disclosure.

As described above, the breaker fluid may be circulated in the wellbore before, during or after the performance of at least one completion operation. In other embodiments, the breaker fluid may be circulated either after a completion operation or after production of formation fluids has commenced to destroy the integrity of and clean up residual drilling fluids remaining inside casing or liners.

Generally, a well is often “completed” to allow for the flow of hydrocarbons out of the formation and up to the surface. As used herein, completion processes may include one or more of the strengthening the well hole with casing, evaluating the pressure and temperature of the formation, and installing the proper completion equipment to ensure an efficient flow of hydrocarbons out of the well or in the case of an injector well, to allow for the injection of gas or water. Completion operations, as used herein, may specifically include open hole completions, conventional perforated completions, sand exclusion completions, permanent completions, multiple zone completions, and drainhole completions, as known in the art. A completed wellbore may contain at least one of a slotted liner, a predrilled liner, a wire wrapped screen, an expandable screen, a sand screen filter, a open hole gravel pack, or casing.

Breaker fluids as disclosed herein may also be used in a cased hole to remove any drilling fluid left in the hole during any drilling and/or displacement processes. Well casing may include a series of metal tubes installed in the freshly drilled hole. Casing serves to strengthen the sides of the well hole, ensure that no oil or natural gas seeps out of the well hole as it is brought to the surface, and to keep other fluids or gases from seeping into the formation through the well. Thus, during displacement operations, typically, when switching from drilling with an oil-based mud to a water-based mud (or vice versa), the fluid in the wellbore is displaced with a different fluid. For example, an oil-based mud may be displaced by another oil-based displacement to clean the wellbore. The oil-based displacement fluid may be followed with a water-based displacement fluid prior to beginning drilling or production. Conversely, when drilling with a water-based mud, prior to production, the water-based mud may be displacement water-based displacement, followed with an oil-based displacement fluid. Further, one skilled in the art would appreciate that additional displacement fluids or pills, such as viscous pills, may be used in such displacement or cleaning operations as well, as known in the art.

Another embodiment of the present disclosure involves a method of cleaning a wellbore drilled with a drilling fluid and forming a filter cake on the wellbore. In one such illustrative embodiment, the method involves circulating a breaker fluid disclosed herein in a wellbore, and then shutting in the well for a predetermined amount of time to allow penetration and fragmentation of the filtercake to take place. As used herein, “shutting in,” such as for a well, may include closing using a valve, ceasing operation, and/or reducing the amount of flow through. Upon fragmentation of the filter cake, the residual drilling fluid may be easily washed out of the well bore. Alternatively, a wash fluid (different from the breaker fluid) may be circulated through the wellbore prior to commencing production.

The fluids disclosed herein may also be used in a wellbore where a sand control screen is installed down hole. After a hole is drilled and/or under-reamed to widen the diameter of the hole, drilling string may be removed and replaced with basepipe having a desired sand control screen. Alternatively, an expandable tubular sand control screen may be expanded in place or a gravel pack may be utilized to complete the well. Breaker fluids may then be placed in the annulus of the open-hole of the well, and the well is then shut in to allow fragmentation of the filtercake to take place. More often the shut-in is concurrent with post completion process such as running tubing, a flow line or assembling surface equipment. Upon fragmentation of the filter cake, the fluids can be produced from the well bore with less drawdown upon initiation of production and thus any residual fluid is easily produced out of the well bore. Alternatively, a lighter fluid (different from the breaker fluid) may be circulated through the wellbore prior to initiate production.

However, the breaker fluids disclosed herein may also be used in various embodiments as a displacement fluid. As used herein, a displacement fluid is typically used to physically push another fluid out of the wellbore. When also used as a displacement fluid, the breaker fluid of the present disclosure may promote dual functionality: effectively push or displace the drilling fluid from the wellbore or open hole and subsequently remain in the penhole in contact with the residual filtercake and initiate degradation.

The precipitated silica may, in some embodiments, provide additional viscosity and density, minimizing or eliminating the need for the application of high density brines or transitioning to an aqueous breaker fluid system during well completion operations. Further, embodiments herein may provide for added delay in breaking of the filter cake, providing additional time for wellbore operations to take place, where the added delay may be provided by the viscosifying effect of the precipitated silica and/or the lack of added water to the breaker fluid.

The foregoing description of the embodiments has been provided for purposes of illustration and description. Although the preceding description has been described herein with reference to particular means, materials, and embodiments, it is not intended to be limited to the particulars disclosed herein; rather, it extends to all functionally equivalent structures, methods, and uses, such as are within the scope of the appended claims.

1. A method of cleaning a wellbore, the method comprising:
emplacing a breaker fluid into the wellbore proximate a filter cake, the breaker fluid comprising:
an oleaginous base fluid,
a precipitated silica, and
at least one of an acid source and a chelant; and
shutting in the well for a period of time.

2. A method for completing a wellbore, comprising:
drilling the wellbore with a drilling fluid and forming a filtercake on the walls thereof;
gravel packing at least one interval of the wellbore;
emplacing a breaker fluid into the wellbore, the breaker fluid comprising:
an oleaginous base fluid;
a precipitated silica; and
at least one of an acid source and a chelant.

3. The method of claim 3, wherein the breaker fluid comprises both an acid source and a chelant.

4. The method of claim 3, wherein the oleaginous fluid comprises at least one selected from diesel oil, a mixture of diesel and paraffin oil, mineral oil, and isomerized olefins.

5. The method of claim 3, wherein the average particle diameter of the precipitated silica is less than 50 μm.

6. The method of claim 3, wherein the precipitated silica is a surface-modified precipitated silica comprising a lipophilic coating.

7. The method of claim 6, wherein the lipophilic coating comprises at least one of a polysiloxane, an aminoalkylsilane, and an alkoxyorganomercaptosilane.

8. The method of claim 3, wherein the breaker fluid further comprises a micronized weighting agent.

9. The method of claim 3, wherein the breaker fluid is an all-oil breaker fluid essentially free of free water prior to emplacement in the wellbore.

10. The method of claim 3, wherein the breaker fluid further comprises water.

11. The method of claim 3, further comprising performing at least one completion operation in the wellbore.

12. The method of claim 3, further comprising initiating production of formation fluids through the wellbore.

13. A breaker fluid, comprising:
a non-aqueous base fluid;
a precipitated silica; and
at least one of an acid source and a chelant.

14. The breaker fluid of claim 13, wherein the breaker fluid comprises both an acid source and a chelant.

15. The breaker fluid of claim 13, wherein the precipitated silica is a surface-modified precipitated silica.

16. The breaker fluid of claim 15, wherein the surface-modified precipitated silica comprises a lipophilic coating.

17. The breaker fluid of claim 16, wherein the lipophilic coating comprises at least one of a polysiloxane, an aminoalkylsilane, and an alkoxyorganomercaptosilane.

18. The breaker fluid of claim 17, further comprising a micronized weighting agent.

19. The breaker fluid of claim 18, wherein the precipitated silica is present in an amount ranging from about 5 ppb to about 40 ppb, based on a total volume of the fluid.

20. The breaker fluid of claim 18, wherein the breaker fluid is an all-oil breaker fluid.

21. The breaker fluid claim 18, further comprising water.
